(19) United States
(12) Patent Application Publication
(10) Pub. No.: US 2012/0056845 A1
(43) Pub. Date: Mar. 8, 2012

(54) TOUCH SCREEN

(75) Inventors: Woon Chun Kim, Gyunggi-do (KR); Yong Soo Oh, Gyunggi-do (KR); Won Ha Moon, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 13/014,945

(22) Filed: Jan. 27, 2011

(30) Foreign Application Priority Data
Sep. 8, 2010 (KR) 1020100088009

(51) Int. Cl. G06F 3/045; G06F 3/041

(52) U.S. Cl. 345/174; 345/173

(57) ABSTRACT

Disclosed herein is a touch screen including a touch panel and a window disposed at a top side of the touch panel. In particular, a groove part is formed in the window or the lower substrate and the touch panel is configured in the groove part to reduce an interface of the touch panel, exposed to the outside, thereby making it possible to prevent infiltration of moisture and oil.

### CROSS REFERENCE TO RELATED APPLICATION

This application claims the benefit of Korean Patent Application No. 10-2010-0088009, filed on Sep. 8, 2010, entitled “Touch Screen” which is hereby incorporated by reference in its entirety into this application.

### BACKGROUND OF THE INVENTION

1. Technical Field

The present invention relates to a touch screen.

2. Description of the Related Art

With the development of the mobile communication technology, user terminals such cellular phones, PDAs, and navigations can serve as a display unit that simply displays character information as well as a unit for providing various and complex multi-media such as audio, moving picture, radio internet web browser, etc. Due to a recent demand for a larger display screen within a terminal having a limited size, a display scheme adopting a touch screen has been more in the limelight. The touch screen combines a screen and coordinate input units, thereby saving space as compared to a key input scheme according to the prior art.

The touch screens currently and mainly used are classified into two types.

First, a resistive touch screen has a structure in which an upper substrate formed with an upper resistive film and a lower substrate formed with a lower resistive film are spaced from each other by a spacer and are disposed to be in contact with each other by external pressure. When an upper substrate formed with an upper electrode film is pressed by an input unit such as fingers, pens or the like, the upper/lower electrode films are conducted and a change in voltage according to a change in resistance value of the positions is recognized by a controller, such that the touched coordinates are recognized.

A capacitive touch screen has a structure in which an upper substrate formed with a first electrode pattern having a first directionality and a lower substrate formed with a second electrode pattern having a second directionality are spaced from each other and an insulator is inserted therebetween in order to prevent the first electrode pattern from contacting the second electrode pattern.

As an input unit touches a touch screen, the capacitive touch screen measures a change in capacitance generated from the first electrode pattern and the second electrode pattern to calculate the coordinates of a touched point.

Both touch screens are formed by stacking the upper substrate and the lower substrate formed with the resistive films or the electrode patterns, such that a plurality of interfaces are formed. Even the touch screen is mounted on a display device, these interfaces are exposed to the outside. In particular, the interfaces are exposed to the outside from side surfaces of the touch screen.

In the resistive touch screen, moisture infiltrates into the interface exposed to the outside, for example, between the upper substrate and the spacer or between the lower substrate and the spacer. In the capacitive touch screen, moisture also infiltrates between the upper substrate and the insulator or between the lower substrate and the insulator. Oil discharged from a user's fingers infiltrates into the interface exposed to the outside according to the use of the touch screen.

The moisture and oil infiltrating as described above changes surface resistance of the resistive films and the electrode patterns of the touch screen, thereby causing malfunction of the touch screen.

### SUMMARY OF THE INVENTION

The present invention has been made in an effort to provide a touch screen that forms a groove part in a window or a lower substrate and configures a touch panel in the groove part to reduce the interface of the touch panel, exposed to the outside, thereby making it possible to prevent moisture and oil from infiltrating.

A touch screen according to a preferred embodiment of the present invention includes: a window formed with a groove part; and a touch panel including a lower substrate having a lower electrode pattern formed on one surface thereof and an upper substrate having an upper electrode pattern formed on one surface thereof, the upper electrode pattern being spaced and disposed from the lower electrode pattern by a spacer, wherein the touch panel is inserted into the groove part so that a top surface of the upper substrate is opposite to a bottom surface of the groove part.

A side surface of the touch panel may be inserted into an inner side surface of the groove part, while being in contact therewith.

A thickness of the touch panel may correspond to a depth of the groove part. The touch panel may be any one of a resistive touch panel and a capacitive touch panel.

A touch screen according to another embodiment of the present invention includes: a touch panel formed with a groove part and including a lower substrate having a lower electrode pattern formed on a bottom surface of the groove part and an upper substrate corresponding to a shape of the groove part and having an upper electrode pattern formed on one surface thereof, the upper electrode pattern being spaced and disposed from the lower electrode pattern by a spacer; and a window formed on a top side of the touch panel.

The spacer and the upper substrate may be formed on an inner side of the groove part.

The window may cover a top surface of the touch panel, corresponding to a shape of the touch panel.

The touch panel may be any one of a resistive touch panel and a capacitive touch panel.

### BRIEF DESCRIPTION OF THE DRAWINGS

FIG. 1 is a cross-sectional view of a touch screen according to a first preferred embodiment of the present invention;

FIG. 2 is a cross-sectional view showing a modified example of the touch screen of FIG. 1;

FIG. 3 is a cross-sectional view of a touch screen according to a second preferred embodiment of the present invention; and

FIG. 4 is a cross-sectional view showing a modified example of the touch screen of FIG. 3.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In describing the present invention, a detailed description of related known functions or configurations will be omitted so as not to obscure the gist of the present invention.

Hereinafter, preferred embodiments of the present invention will be described in detail with reference to the accompanying drawings.

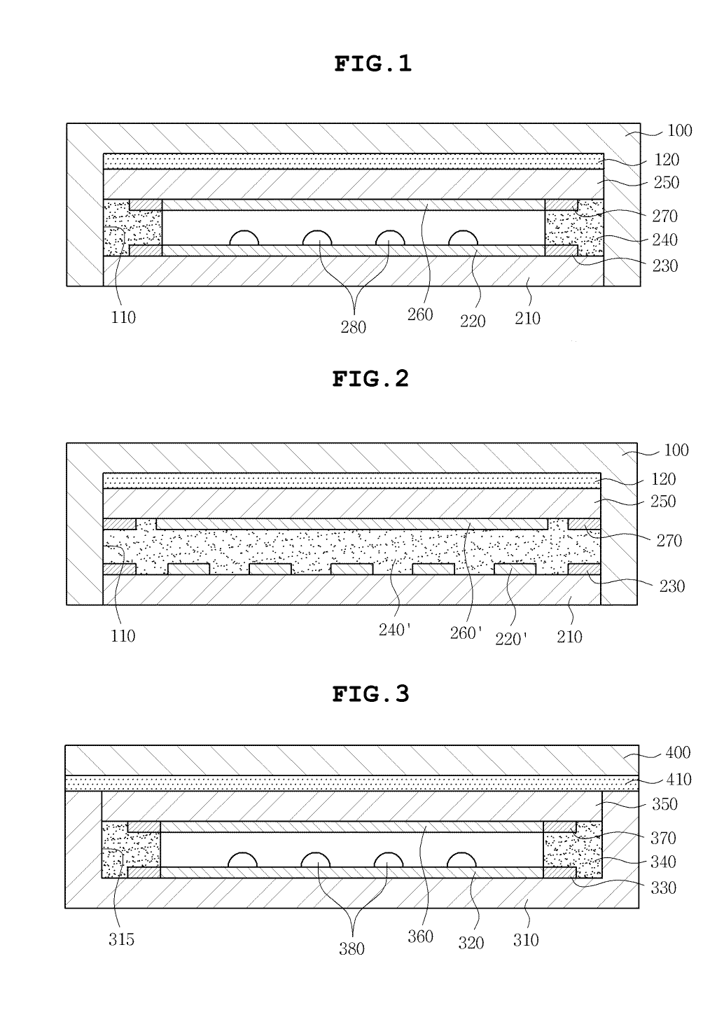

FIG. 1 is a cross-sectional view of a touch screen according to a first preferred embodiment of the present invention, and FIG. 2 is a cross-sectional view showing a modified example of the touch screen of FIG. 1. Hereinafter, a touch screen according to a first preferred embodiment of the present invention will be described with reference to these figures.

In the touch screen according to the present embodiment, a groove part 110 is formed in a window 100 and a touch panel 200 is inserted into the groove part 110. At this time, the touch panel 200 is inserted so that a bottom surface of the groove part 110 in which the window 100 is formed is opposite to a top surface of an upper substrate 250. Therefore, a side surface of the touch panel 200 is covered by an inner side surface of the groove part 110, thereby making it possible to prevent an interface of the touch panel 200 from being exposed to the outside.

At this time, in the present embodiment, the touch panel 200 may adopt a resistive touch panel or a capacitive touch panel.

Describing the resistive touch panel with reference to FIG. 1, the lower substrate 210 having a lower electrode pattern 220 forming a resistive film formed on one surface thereof is spaced from an upper substrate 250 having an upper electrode pattern 260 forming a resistive film formed on an opposite surface by a spacer 240. At this time, the spacer 240 has a shape in which an opening part is formed so that the upper electrode pattern 260 formed on the upper substrate 250 can be in contact with the lower electrode pattern 220 by external pressure. The spacer 240 may be formed of a double-sided adhesive sheet.

In addition, electrode wirings 230 and 270 transferring the change in voltage generated according to the contact of the electrode patterns to a controller are provided in the upper substrate 250 and the lower substrate 210, respectively, so as to be connected to the electrode patterns 220 and 260. At this time, the electrode wirings 230 and 270 provided in the upper substrate 250 and the lower substrate 210 are orthogonal to each other.

Meanwhile, when the electrode pattern has a resistive film shape, an analog resistive touch panel is configured, and when the electrode pattern is formed in plural and has a bar shape (modifiable), a digital resistive touch panel is configured. The lower substrate 210, which is a transparent member, may use a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalate (PEN), polycarbonate (PC), polyethersulfone (PES), polyimide (PI), polyvinylalcohol (PVA), cyclic olefin copolymer (COC), stylene polymer, etc., and are not specifically limited.

The upper substrate 250 may be made of a film substrate so as to be warped by external pressure.

The electrode patterns 220 and 260 are made of a transparent conductive material. In the prior art, a metal oxide such as ITO is generally applied. Research into a technology to form an electrode pattern with a conductive polymer of which manufacturing unit price is cheap has been conducted. The conductive polymer is very weak against moisture. However, the touch screen according to the present embodiment forms the groove part in the window and inserts the touch panel into the groove part to prevent moisture from infiltrating from the outside, thereby making it possible to constantly maintain surface resistance of the electrode pattern.

The conductive polymer may adopt an organic compound, such as polythiophene, Polypyrrole, polyaniline, polyacetylene, polyphenylene, or the like. In particular, among the polythiophene, poly-3,4-ethylenedio xythiophene/polystyrenesulfonate (PEDOT/PSS) compound is most preferable and at least one of the organic compounds may be mixed. In addition, when carbon nanotube or the like is further mixed, conductivity may be further enhanced.

The dot spacer 280 may be formed on the lower electrode pattern 220. In the case of the resistive touch panel, the upper substrate 250 is modified according to the use thereof so that the upper electrode pattern 260 may be in contact with the lower electrode pattern 220, or the upper electrode pattern 260 may be in contact with the lower electrode pattern 220 by minute external pressure. The dot spacer 280 is provided so as to prevent such malfunction. Different from that shown in FIG. 1, the dot spacer 280 may also be formed on the upper electrode pattern 260 instead of the lower electrode pattern 220.

FIG. 2 shows a capacitive touch panel, which is a modified example of the touch screen of FIG. 1.

In the capacitive touch panel, a plurality of electrode patterns 220′ and 260′ are formed on the lower substrate 210 and the upper substrate 250. At this time, the upper electrode pattern 260′ and the lower electrode pattern 220′ are disposed to be orthogonal to each other. The spacer 240′ covers the entire lower substrate 210 so that the upper electrode pattern 260′ and the lower electrode pattern 220′ are spatially separate.

At this time, the electrode patterns 220′ and 260′ may be formed in a bar type or a type in which a polygonal sensing part and a connection part are repeated. The capacitive touch panel measures a change in capacitance when the touch panel is touched by a user's finger, thereby obtaining coordinate information on the touched point.

The touch panel 200 described with reference to FIGS. 1 and 2 is inserted into the groove part 110 of the window 100, wherein the touch panel 200 may be bonded to the window 100 using an optical adhesive 120 such as an optical clear adhesive (OCA).

The window 100 may use a film substrate having excellent durability and transparency, preferably, polymethylemethacrylate (PMMA)or polycarbonate (PC).

At this time, the side surface of the touch panel 200 may be inserted to be in contact with the inner side surface of the groove part 110. A plurality of interfaces formed at the side surface of the touch panel 200 are protected by the window 100. In other words, the shape of the touch panel 200 is formed to be the same as that of the groove part, thereby making it possible to minimize infiltration of moisture and oil through the interfaces.

In addition, it is preferable that the thickness of the touch panel 200 correspond to the depth of the groove part 110. The touch panel 200 is bonded, without being protruded into the outside of the window, thereby preventing infiltration of moisture and oil and facilitating the handling of the touch screen. For example, when the touch screen is bonded to the display apparatus, it is possible to secure a wide contact surface.

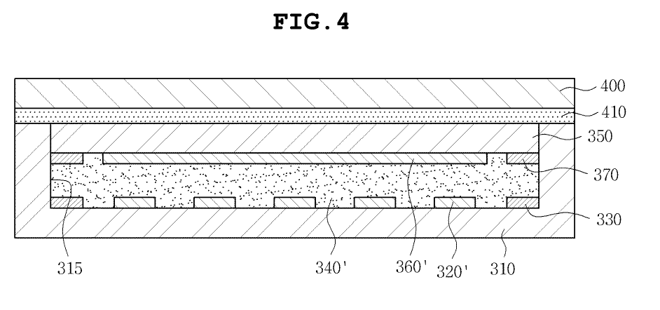

FIG. 3 is a cross-sectional view of a touch screen according to a second preferred embodiment of the present invention, and FIG. 4 is a cross-sectional view showing a modified example of the touch screen of FIG. 3. Hereinafter, a touch screen according to a second preferred embodiment of the present invention will be described with reference to these figures.

The touch screen according to the second embodiment forms a groove part 315 in a lower substrate 310 of a touch panel 300 so as to prevent infiltration of moisture and oil from the outside and forms components of the touch panel on the inner side of the groove part 315. Therefore, the interface of the touch panel 300 exposed to the outside is reduced. The window 400 is disposed at the top side of the touch panel 300, thereby minimizing moisture and oil infiltrating into the top side.

FIG. 3 shows a resistive touch panel. First, a lower electrode pattern 320 in a film shape is formed in the groove part 315 of the lower substrate 310 and a lower electrode wiring 330 is formed to be connected thereto. Next, an upper substrate 350 formed with an upper electrode pattern 360 and an upper electrode wiring 370 is bonded to the lower substrate 310 through a spacer 340 configured of a double-sided adhesive sheet, thereby forming a touch panel.

FIG. 4 shows a capacitive touch panel. The capacitive touch panel is formed through the configuration described with reference to FIG. 2 in the similar manner as described with reference to FIG. 3. At this time, the spacer 340′ is formed to cover the lower electrode pattern 320′ using an optical adhesive sheet.

In addition, the window 400 is formed on the top side of the touch panel 300 using an optical adhesive 410 such as an OCA. A flat member is used as the window 400 according to the present embodiment, different from the shape of the window shown in FIGS. 1 and 2.

At this time, it is preferable that the spacer 340′ spacing the lower electrode pattern 320′ from the upper electrode pattern 360′ and the upper substrate 350 are formed on the inner side (the thickness of the spacer 340′ and the upper substrate 350 being equal to or smaller than the depth of the groove part) of the groove part 315 formed in the lower substrate 310. In particular, it is preferable that the upper substrate 350 is formed such that the groove part 315 does not deviate which subsequently prevents the touch panel 300 from protruding.

If the upper substrate 350 is protruded to the outside of the groove part 315, the side surface of the touch panel 300 may be partially exposed and it may be difficult to form the window 400. As a result, it is preferable that the upper substrate 350 is formed on the inner side of the groove part 315.

In addition, it is preferable that the window 400 bonded to the top side of the touch panel 300 covers the entire touch panel, corresponding to the shape of the touch panel 300. As shown in FIGS. 3 and 4, moisture and oil may infiltrate into the interface between the inner side surface of the groove part 315 and the side surface of the upper substrate 350, such that the window 400 is formed to be larger than the upper substrate 350 so as to prevent infiltration thereof. In other words, it is preferable that the window 400 corresponding to the shape of the touch panel 300 is used to cover such an interface.

The present invention forms a groove part in a window and inserts a touch panel into the groove part to reduce the number of interfaces exposed to the outside, thereby making it possible to prevent moisture and oil from infiltrating from the outside.

In addition, the present invention forms a groove part in a lower substrate configuring a touch screen and forms the touch panel in the groove part to stack the window thereon, thereby making it possible to minimize the number of interfaces exposed to the outside.

Therefore, the touch screen according to the present invention can constantly maintain surface resistance value of resistive films or electrode patterns of a touch screen, thereby showing constant sensitivity.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen, comprising:
a window formed with a groove part; and
a touch panel including a lower substrate having a lower electrode pattern formed on one surface thereof and an upper substrate having an upper electrode pattern formed on one surface thereof, the upper electrode pattern being spaced and disposed from the lower electrode pattern by a spacer,
wherein the touch panel is inserted into the groove part so that a top surface of the upper substrate is opposite to a bottom surface of the groove part.

2. The touch screen as set forth in claim 1, wherein a side surface of the touch panel is inserted into an inner side surface of the groove part, while being in contact therewith.

3. The touch screen as set forth in claim 1, wherein a thickness of the touch panel corresponds to a depth of the groove part.

4. The touch screen as set forth in claim 1, wherein the touch panel is any one of a resistive touch panel and a capacitive touch panel.

5. A touch screen, comprising:
a touch panel formed with a groove part and including a lower substrate having a lower electrode pattern formed on a bottom surface of the groove part and an upper substrate corresponding to a shape of the groove part and having an upper electrode pattern formed on one surface thereof, the upper electrode pattern being spaced and disposed from the lower electrode pattern by a spacer; and
a window formed on a top side of the touch panel.

6. The touch screen as set forth in claim 5, wherein the spacer and the upper substrate are formed on an inner side of the groove part.

7. The touch screen as set forth in claim 5, wherein the window covers a top surface of the touch panel, corresponding to a shape of the touch panel.

8. The touch screen as set forth in claim 5, wherein the touch panel is any one of a resistive touch panel and a capacitive touch panel.
